(19) United States
(12) Patent Application Publication
(10) Pub. No.: US 2025/0161922 A1
(43) Pub. Date: May 22, 2025

(54) RU-BASED CATALYSTS FOR AMMONIA SYNTHESIS AT MILD CONDITIONS

(71) Applicant: Khalifa University of Science and Technology, Abu Dhabi (AE)

(72) Inventors: Kyriaki POLYCHRONOPOULOU, Abu Dhabi (AE); Swati SINGH, Abu Dhabi (AE); Eswara Vara Prasadarao K KOMARALA, Abu Dhabi (AE)

(21) Appl. No.: 18/517,868

(22) Filed: Nov. 22, 2023

(51) Int. Cl. B01J 23/89; B01J 35/64; B01J 37/02; B01J 37/08; C01B 21/087

(52) U.S. Cl. CPC B01J 23/8946; B01J 35/647; B01J 37/0201; B01J 37/08; C01B 21/087

(57) ABSTRACT

The present disclosure relates to ruthenium-based catalysts for ammonia (NH₃) synthesis at mild conditions and methods of preparing the ruthenium-based catalysts. The ruthenium-based catalyst includes a MgFeOₓ support and ruthenium metal loaded onto the support, wherein the catalyst has the chemical formula of MgFeOₓ—Ru, wherein x is the number of oxygen atoms present. In an example, x is equal to four. The MgFeOₓ support is prepared from MgFe layered double hydroxide (LDH). An amount of ruthenium present in the ruthenium-based catalyst ranges from about 0.1 to about 1.0 wt %.

### BACKGROUND

There are many aspects of modern energy systems that rely heavily on fossil fuels, such as manufacturing, transportation, and living. Approximately 80% of global energy consumption is generated from fossil fuels such as petroleum, coal, and natural gas. Consequently, CO₂ emissions increase dramatically, resulting in global warming issues. Many nations have proposed an “energy transition” towards net-zero carbon emission by 2050 and have focused on the development of clean energy solutions, which aim to reduce environmental impact and fossil fuel use. Water is the only product of hydrogen, making it a viable clean energy vector. It is commonly stored as a compressed gas at 700 bar at 25° C. or as a liquid at 253° C. due to its low energy density. In addition, H₂ will diffuse through the materials used to store it, causing them to become embrittled or weak. Due to these issues, hydrogen is not a practical fuel based on current technologies and presents unexpected risks. As an alternative, ammonia (NH₃) is an ideal hydrogen carrier due to its high hydrogen content (17.8% by weight), high volumetric density, and the ability to be liquefied at 8 bar at 25° C. Additionally, ammonia has no carbon footprint and is increasingly considered an energy vector instead of a chemical in fertilizer manufacturing. Traditional NH₃ production involves the fossil-fuel-dependent Haber-Bosch process. H₂ feed gas is commonly obtained by cracking fossil fuels at a large scale, and NH₃ synthesis requires very high temperatures and very high pressures over conventional Fe-based catalysts. The process consumes about 2% of global energy.

In catalysis, the synthesis of NH₃ has been the bellwether reaction, boosting the fundamental understanding and industrialization of heterogeneous catalysis. NH₃ synthesis is also known to involve reversible reactions such as NH₃ decomposition into N₂ and H₂, for which catalyst applications are strongly related to NH₃ synthesis research. There have been various catalysts developed so far, such as Fe, Co, Ni, and Ru-based catalysts that are active for both decomposition and synthesis of NH₃. The Ru-based catalysts exhibit twenty-fold more activity than Fe-based catalysts used in the Haber-Bosch process. The Ru-based catalysts also have a wider range of H₂ and N₂ ratios than Fe-based catalysts. Further, sustainable NH₃ production using renewable energy promotes NH₃ synthesis and degradation under mild conditions. The Ru (ruthenium) metal is ideal for catalyzing ammonia synthesis at mild conditions, such as low pressures and temperatures. However, there are 30 tons of Ru produced every year, which makes it one of the scarcer metals. Ru-based catalysts have become prohibitively expensive, with estimated costs of $64,000 USD/ton of catalyst in 2015 and $740,000 USD/ton of catalyst in 2021, making them unsuitable for industrial ammonia synthesis despite the high recovery rate of Ru.

It would be beneficial to develop an efficient and stable Ru-based catalyst that can make use of ruthenium in an affordable and sustainable manner.

### SUMMARY

According to one aspect, a ruthenium-based catalyst for ammonia synthesis includes a MgFeOₓ support and a ruthenium metal loaded onto the support to form the ruthenium-based catalyst. The ruthenium-based catalyst has the chemical formula of MgFeOₓ—Ru, and x is the number of oxygen atoms present.

According to another aspect, a method of making a ruthenium-based catalyst includes calcining a MgFe LDH powder to form a MgFeOₓ support, loading ruthenium onto the MgFeOₓ support, and reducing the loaded support to form the ruthenium-based catalyst. The ruthenium-based catalyst has a chemical formula of MgFeOₓ—Ru and x is the number of oxygen atoms present.

According to another aspect, a method of synthesizing ammonia from a feed including at least one of nitrogen and hydrogen includes preparing or providing a Ruthenium-based catalyst comprising a MgFeOₓ support and a ruthenium metal loaded onto the support to form the ruthenium-based catalyst, and exposing a gas feed composition comprising N₂ and H₂ to the catalyst at a predetermined flow rate to convert N₂ to NH₃.

This summary is intended to provide an overview of subject matter of the present disclosure. It is not intended to provide an exclusive or exhaustive explanation of the invention. The detailed description is included to provide further information about the present patent application.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 is a flowchart illustrating the steps utilized in the method for synthesis of a ruthenium-based catalyst, according to some embodiments.

FIG. 2 shows images of powder samples of as-synthesized MgFeOₓ-nRu catalysts, n=0.2, 0.5, and 1 wt. % Ru loading.

FIG. 3 shows the XRD patterns of MgFe LDH, MgFeOₓ support, and MgFeOₓ-nRu (n=0.2, 0.5, and 1 wt. %) catalysts.

FIG. 4(a)-FIG. 4(c) show the SEM-EDS imaging and mapping of MgFeOₓ-0.2Ru FIG. 4(a), MgFeOₓ-0.5Ru FIG. 4(b) and MgFeOₓ-1Ru FIG. 4(c) catalysts.

FIG. 5(a)-FIG. 5(g) show the TEM-HAADF analysis along with RGB elemental mapping of reduced MgFeOₓ-0.2Ru catalysts: FIG. 5(a) shows the TEM micrograph. FIG. 5(b) shows the HAADF image of the selected area and their corresponding elemental mapping for the elements Mg (FIG. 5(c)), Fe (FIG. 5(d)), Ru (FIG. 5(e)), (f) O (FIG. 5(f)), and RGB (FIG. 5(g)) overlap of all elements.

FIG. 6(a) shows the N₂ adsorption-desorption hysteresis of MgFe LDH, MgFeOₓ support, and MgFeOₓ-nRu catalysts; and FIG. 6(b) show their corresponding pore size distribution profiles.

FIG. 7 shows the H₂-Temperature programmed reduction (TPR) profiles of MgFeOₓ-nRu catalysts in 10% H₂ with a heating rate of 10° C./min.

FIG. 8 shows the H₂-Temperature programmed desorption (TPD) profiles of MgFeOₓ-nRu catalysts in 10% H₂ with a heating rate of 10° C./min.

FIG. 9(a)-FIG. 9(c) show the XPS spectra of 3d_{3/2} and 3d_{5/2} of MgFeOₓ-0.2Ru (FIG. 9(a)), MgFeOₓ-0.5Ru (FIG. 9(b)), and MgFeOₓ-1Ru catalyst (FIG. 9(c)).

FIG. 10 shows the rate of NH₃ synthesis of MgFeOₓ-0.2Ru, MgFeOₓ-0.5Ru, and MgFeOₓ-1Ru catalysts at 400° C., 10,000 mL g⁻¹ h⁻¹ WHSV and different pressure ranges.

FIG. 11 shows the effect of pressure on NH₃ formation rate of MgFeOₓ-0.2Ru catalyst at 400° C. and 10,000 mL g⁻¹ h⁻¹ WHSV.

FIG. 12 shows the long-term stability test of MgFeOₓ-0.2Ru catalyst at 400° C. and 10,000 mL g⁻¹ h⁻¹ WHSV.

FIG. 13 shows the effect of Weight hour space velocity (WHSV) on NH₃ synthesis rate of MgFeOₓ-0.2Ru catalyst.

FIG. 14 shows a comparison of the synthesized ruthenium catalyst with Ru-based catalysts reported in literature. m: similar compositions as KAAP catalysts; n: commercial Fe catalyst having similar compositions as Mittasch's catalyst.

### DETAILED DESCRIPTION

The present disclosure is directed to ruthenium-based catalysts for use in ammonia synthesis. Ruthenium-based catalysts have received considerable interest in NH₃ catalysis due to their superior catalytic performance. However, ruthenium is a scarce metal and its high price inhibits its use in commercial applications. The present disclosure is directed to the synthesis of Ru-based catalysts that create active sites on the surface of these catalysts in order to achieve atomic efficiency.

The ruthenium-based catalyst of the present disclosure can be formed by loading ruthenium metal onto a MgFeOₓ support. The support can be prepared from MgFe layered double hydroxide (LDH). The systems and methods disclosed herein result in high dispersion of Ru over the support, which in turn provides more active sites for catalytic activity. The Ru-based catalysts were prepared with different loadings of Ru in order to determine the optimal concentration for maximum catalytic activity. A chemical reduction method was used to prepare the catalysts, and the loading of Ru was 0.2, 0.5, and 1 wt. %. Various characterization techniques were employed to examine the physical and chemical properties of the catalysts, including X-ray diffraction (XRD), scanning electron microscopy (SEM), High-resolution transmission electron microscopy (HRTEM), X-ray photoelectron spectroscopy, N₂-adsorption, H₂ Temperature-programmed Reduction (TPR) and H₂-Temperature-programmed Desorption (TPD).

Embodiments of the present disclosure describe a ruthenium-based catalyst for ammonia synthesis, comprising an MgFeOₓ support and ruthenium metal loaded on to the support, wherein the catalyst has the chemical formula of MgFeOₓ—Ru, where x is the number of oxygen atoms present. In one example, x is equal to 4. Some embodiments of the present disclosure describe a ruthenium-based catalyst in which an amount of ruthenium present in the ruthenium-based catalyst (i.e. a concentration of ruthenium in the catalyst) is between about 0.1 and about 1.0 wt %. Some embodiments of the present disclosure describe a ruthenium-based catalyst, wherein the support is prepared from MgFe layered double hydroxide (LDH).

In some embodiments, the amount of ruthenium present in the ruthenium-based catalyst is between about 0.1 and about 1.0 wt %, in other embodiments between about 0.1 and about 0.7 wt. %, in other embodiments between about 0.1 and about 0.3 wt. %, and in yet other embodiments between about 0.3 and about 0.7 wt. %. In some embodiments, the concentration of ruthenium in the ruthenium-based catalyst is about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1.0 wt %. Some embodiments of the present disclosure describe a ruthenium-based catalyst, wherein the Mg to Fe ratio is between about 2:1 and about 3:1 (atomic ratio). In some embodiments, the Mg to Fe ratio is about 2:1. In other embodiments, the Mg to Fe ratio is about 2.1:1, about 2.2:1, about 2.3:1, about 2.4:1, about 2.5:1, about 2.6:1, about 2.7:1, about 2.8:1, about 2.9:1 or about 3.0:1. Yet other embodiments of the present disclosure describe a ruthenium-based catalyst, wherein the Fe and Ru are closely associated with each other in the form of an alloy.

Certain embodiments of the present disclosure describe a ruthenium-based catalyst, wherein the pore size of the catalyst is in the range of about 4 to about 25 nm. Some embodiments of the present disclosure describe a ruthenium-based catalyst, wherein the pore size of the catalyst is in the range of about 5 to about 20 nm. Certain other embodiments of the present disclosure describe a ruthenium-based catalyst, wherein the pore size of the catalyst is in the range of about 6 to about 10 nm.

Some embodiments of the present disclosure describe a ruthenium-based catalyst, wherein Ru preferentially resides on the surface of the catalyst.

Yet other embodiments of the present disclosure describe a ruthenium-based catalyst, wherein the rate of ammonia synthesis increases with the decrease in Ru loading. Certain other embodiments of the present disclosure describe a ruthenium-based catalyst, wherein the rate of ammonia synthesis increases with the increase in pressure.

Some embodiments of the present disclosure describe a ruthenium-based catalyst, wherein the catalyst exhibits long term stability. Other embodiments of the present disclosure describe a ruthenium-based catalyst, wherein the duration of stability of the catalyst is 130-170 hours. Yet other embodiments of the present disclosure describe a ruthenium-based catalyst, wherein the duration of stability of the catalyst is 150 hours.

Some embodiments of the present disclosure describe a ruthenium-based catalyst, wherein the catalyst exhibits stability at temperatures in the range of 325-475° C. Yet other embodiments of the present disclosure describe a ruthenium-based catalyst, wherein the catalyst exhibits stability at temperatures of about 400° C.

Some embodiments of the present disclosure describe a ruthenium-based catalyst, wherein the catalyst exhibits high catalytic activity at a high flow rate of 50000 mLg⁻¹ h⁻¹.

Embodiments of the present disclosure describe a method of making a ruthenium-based catalyst, comprising calcining a MgFe LDH powder to form a MgFeOₓ support. This is followed by loading ruthenium on to the MgFeOₓ support and reducing the loaded support to form the ruthenium-based catalyst. The ruthenium-based catalyst has a chemical formula of MgFeOₓ—Ru where x is the number of oxygen atoms present. In one example, x is equal to 4. The MgFe LDH structure is calcined and the result is an MgFeO_{4-δ} [δ=±0.1] spinel structure. The δ value depends upon the O vacancy created in the structure during the calcination, which can be uncertain and hence the δ range provided herein.

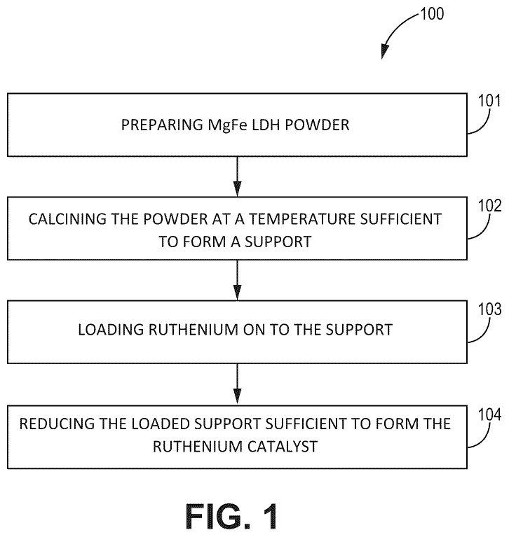

FIG. 1 is a flowchart of a method 100 of making a ruthenium-based catalyst, according to one or more embodiments of the present disclosure. As shown in FIG. 1, the method may comprise preparing (101) MgFe LDH powder and calcining (102) the powder at a temperature sufficient to form a support. This is followed by loading (103) ruthenium on to the support and reducing (104) the above sufficiently to form the ruthenium-based catalyst; wherein the catalyst has a chemical formula of MgFeOₓ-nRu where x is the number of oxygen atoms present, and n is the wt. % of ruthenium loaded. In some embodiments, x is equal to 4.

Step 101 includes preparing MgFe LDH powder. MgFe LDH was prepared using the method reported in the literature. Alternatively, the method 100 can include obtaining the MgFe LDH powder. Step 102 includes calcining the powder at a temperature sufficient to form a support. The powder obtained from step 101 was then calcined at 600° C. for 5 hours with a heating rate of 10° C./min to obtain the support (MgFeOₓ). For some embodiments of the present disclosure, the powder was calcined at a temperature range of about 550° C. to about 650° C. For yet other embodiments of the present disclosure, the powder was calcined at a temperature range of about 575° C. to about 625° C. In some embodiments, the temperature is about 600° C. For some embodiments of the present disclosure, the powder was calcined for a period of about 3 to about 7 hours. For some embodiments of the present disclosure, the powder was calcined for a period of about 4 to about 9 hours. In some embodiments, the time for calcining is about 5 hours.

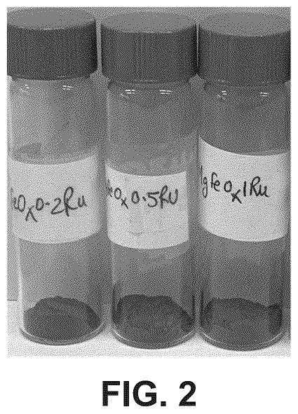

Step 103 includes loading ruthenium on to the support and step 104 includes reducing the above sufficient to form the ruthenium-based catalyst; wherein the catalyst has a chemical formula of MgFeOₓ-nRu where x is the number of oxygen atoms present, and n is the wt % of ruthenium loaded. The MgFeOₓ-nRu (n=0.2, 0.5, and 1 wt. %) catalysts with different Ru loading were prepared using chemical reduction method previously reported in the literature. FIG. 2 shows the powder images of the synthesized MgFeOₓ-nRu. The color difference in the powder samples describes different Ru loading of the produced catalysts.

Embodiments of the present disclosure describe a method of making a ruthenium-based catalyst, wherein a concentration of ruthenium in the catalyst varies from about 0.1 to about 1 wt %. Some embodiments of the present disclosure describe a method of making a ruthenium-based catalyst, wherein the Mg to Fe ratio in the catalyst is about 2:1 (atomic ratio). In other embodiments, the atomic ratio of Mg to Fe is between about 2:1 and about 3:1. Other embodiments of the present disclosure describe a method of making a ruthenium-based catalyst, wherein the catalyst has Fe and Ru closely associated with each other in the form of an alloy.

Embodiments of the present disclosure describe a method of making a ruthenium-based catalyst, wherein the pore size of the catalyst is in the range of about 4 to about 25 nm. Yet other embodiments of the present disclosure describe a method of making a ruthenium-based catalyst, wherein the pore size of the catalyst is in the range of about 5 to about 20 nm. Certain embodiments of the present disclosure describe a method of making a ruthenium-based catalyst, wherein the pore size of the catalyst is in the range of about 6 to about 10 nm.

Some embodiments of the present disclosure describe a method of making a ruthenium-based catalyst, wherein Ru preferentially resides on the surface of the catalyst. Some embodiments of the present disclosure describe a method of making a ruthenium-based catalyst, wherein the rate of ammonia synthesis increases with the decrease in Ru loading. Certain embodiments of the present disclosure describe a method of making a ruthenium-based catalyst, wherein the rate of ammonia synthesis increases with the increase in pressure.

Some embodiments of the present disclosure describe a method of making a ruthenium-based catalyst, wherein the catalyst exhibits long term stability. Some embodiments of the present disclosure describe a method of making a ruthenium-based catalyst, wherein the duration of stability of the catalyst is 130-170 hours. Yet other embodiments of the present disclosure describe a method of making a ruthenium-based catalyst, wherein the duration of stability of the catalyst is 150 hours.

Some embodiments of the present disclosure describe a method of making a ruthenium-based catalyst, wherein the catalyst exhibits stability at temperatures in the range of 325-475° C. Yet other embodiments of the present disclosure describe a method of making a ruthenium-based catalyst, wherein the catalyst exhibits stability at a temperature of 400° C. Some embodiments of the present disclosure describe a method of making a ruthenium-based catalyst, wherein the catalyst exhibits high catalytic activity at a high flow rate of 50000 mLg⁻¹ h⁻¹.

Some embodiments of the present disclosure describe a method for synthesizing ammonia from a feed including at least one of nitrogen and hydrogen. The method can include preparing (synthesizing) or providing a ruthenium-based catalyst comprising a MgFeOₓ support and a ruthenium metal loaded onto the support to form the ruthenium-based catalyst, and exposing a gas feed composition comprising N₂ and H₂ to the catalyst at a predetermined flow rate to convert N₂ to NH₃. In some embodiments, the predetermined flow rate is at least 50000 mLg⁻¹ h⁻¹. In some embodiments, the method is performed at a pressure between about 10 bar and about 50 bar. In some embodiments, the method is performed at a temperature between about 250 and about 500 degrees Celsius. In some embodiments, the method includes mixing the catalyst with a silicon carbine powder to form a catalyst mixture and containing the catalyst mixture in a tube reactor prior to the exposing step. In some embodiments, the gas feed composition is about 25 percent N₂ and about 75 percent H₂.

A catalytic activity test can be conducted to determine the efficacy of the Ru-based catalyst for ammonia production. The preparation for the catalytic activity test involves diluting 67.5 mg of the catalyst with 500 mL of coarse silicon carbide powder (46 grit) obtained from Alfa Aesar, Lot 10226827. The reactor used for the test is a quartz tube with an inner diameter of 2 mm and an outer diameter of 3 mm, equipped with a porosity 3 filter. During the test, a gas flow of 10,000 mL/g/h WHSV (weight hourly space velocity) is maintained. The feed composition consists of 25% N₂ and 75% H₂, with the additional use of Helium (He) to calculate the ammonia flow in the outlet. The concentration of the outlet NH₃ is determined using a TCD (Thermal Conductivity Detector) detector. The initial screening test is conducted under various conditions, including a gas flow of 10,000 mL/g/h, pressure ranging from 10 to 50 bar, and a temperature of 400° C. The aim is to select the most effective catalyst. Following this, a secondary screening test is performed with a gas flow ranging from 10,000 to 50,000 mL/g/h at a fixed pressure of 50 bar and a temperature of 400° C. The reduction process involves subjecting the catalyst to a mixture of 75% H₂ and 25% N₂ at a temperature of 600° C. for a duration of 12 hours. During the actual reaction conditions, the gas flow rates are adjusted as follows: N₂ at 2.5 mL/min, H₂ at 7.5 mL/min, and He at 1.25 mL/min. The reaction is conducted at a constant, pre-determined temperature of 400° C. (in other examples, temperature can range from 250-500° C.), and the pressure is varied between 10 bar and 50 bar to observe the catalytic performance under different pressure conditions.

The following Examples are intended to illustrate the above invention and should not be construed as to narrow its scope. One skilled in the art will readily recognize that the inventors suggest many other ways in which the invention could be practiced. It should be understood that numerous variations and modifications may be made while remaining within the scope of the invention.

### EXAMPLES

### Example 1: Characterization of Synthesized Ruthenium-Based Catalyst

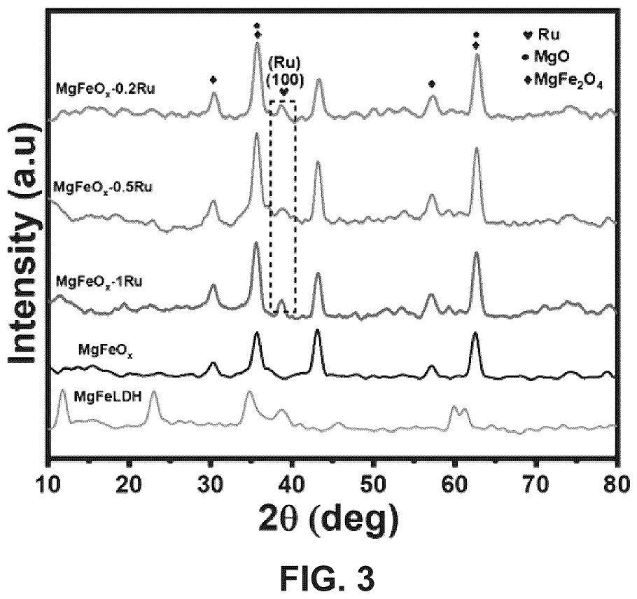

FIG. 3 shows the XRD patterns of as-synthesized LDH, support, and the catalysts. The diffraction pattern of MgFe LDH exhibited a typical rhombohedral hydrotalcite crystal structure. The MgFeOₓ support was obtained after calcining the MgFe LDH at 600° C. in air. The XRD pattern of the support exhibit peaks of Fe₃O₄ phase with slight shift indicating the formation of MgFe₂O₄ phase with an overlap of MgO phase. Further, the XRD patterns of MgFeOₓ-nRu catalysts do not show much difference as compared to the support except appearance of additional peak at 38.6° corresponding to the (100) plane of metallic Ru.

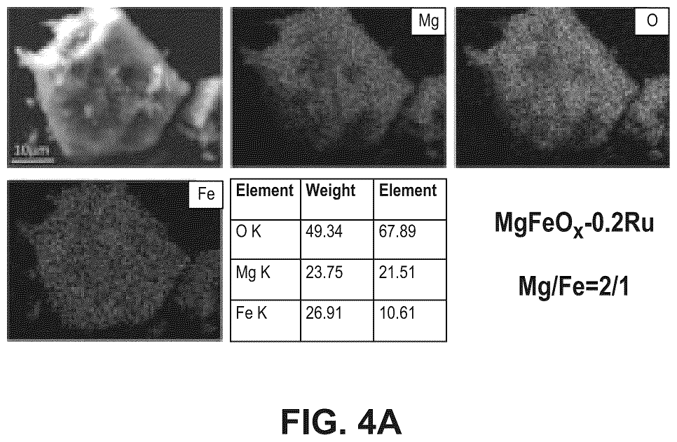

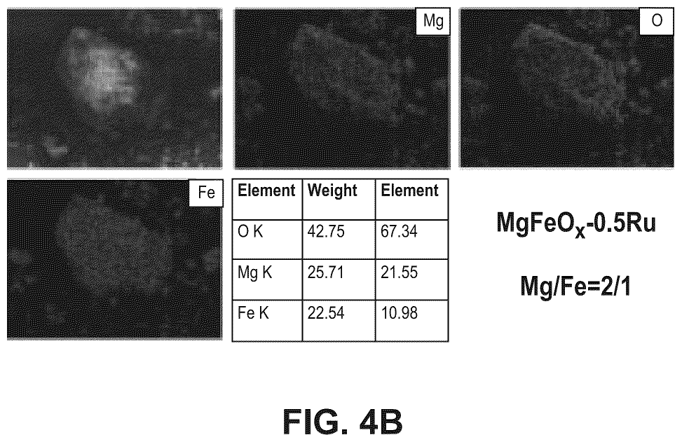

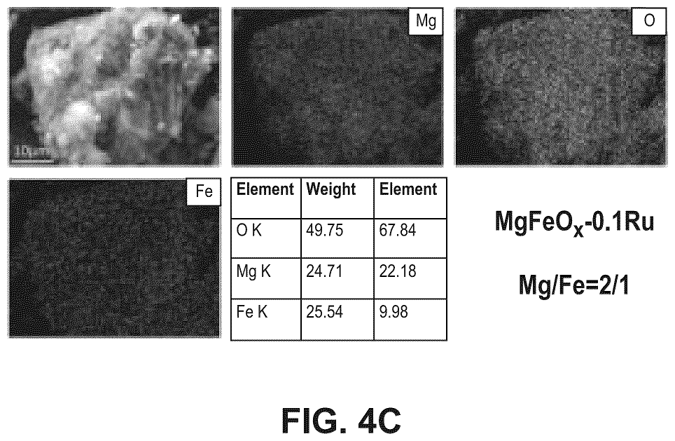

SEM-EDS mapping analysis was conducted to investigate the elemental distribution of as-synthesized catalysts and is shown in FIG. 4(a)-FIG. 4(c). The results revealed a consistent Mg/Fe ratio of 2:1 throughout the sample which is consistent with the quantities of the precursors used for synthesis of LDH phase. This confirms that the composition remains the same even after the calcination of LDH phase to obtain the MgFeOₓ support. However, due to the low content of Ru in the catalysts, the Ru loading could not be observed using EDS mapping due to the limitations of the SEM instrument.

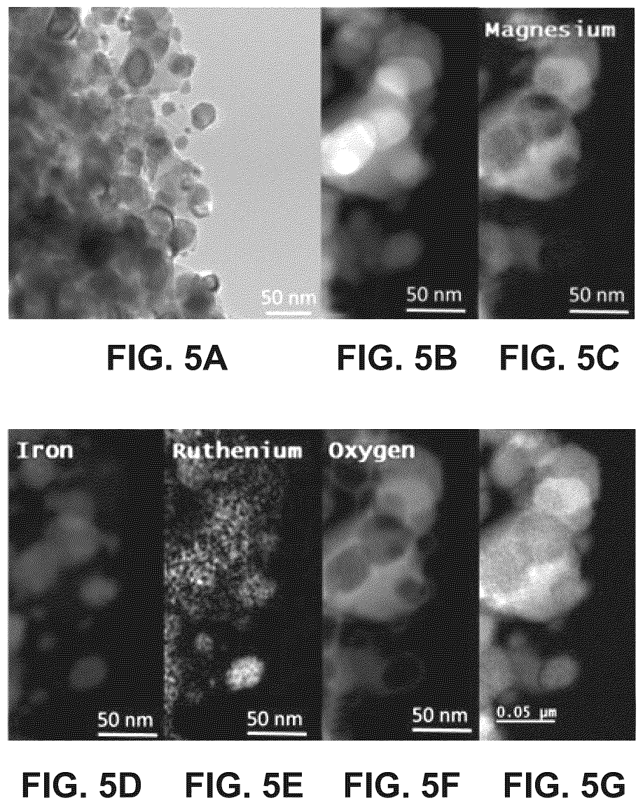

Further, to confirm the Ru loading and/or interaction with the support, TEM analysis was employed on the reduced MgFeOₓ-0.2Ru catalyst (FIG. 5(a)-FIG. 5(g)). FIG. 5(a) shows that the catalyst has nanoparticle morphology with particle size less than 20 nm. FIG. 5(b)-FIG. 5(g) show the HAADF image with the corresponding elemental mapping of the selected area. The elemental mapping (FIG. 5(e)) clearly shows the presence of Ru metal on the catalyst. Interestingly, both Fe and Ru are in metallic phase and are closely associated with each other (FIG. 5(d) and FIG. 5(e)) which confirm the Fe—Ru alloy formation.

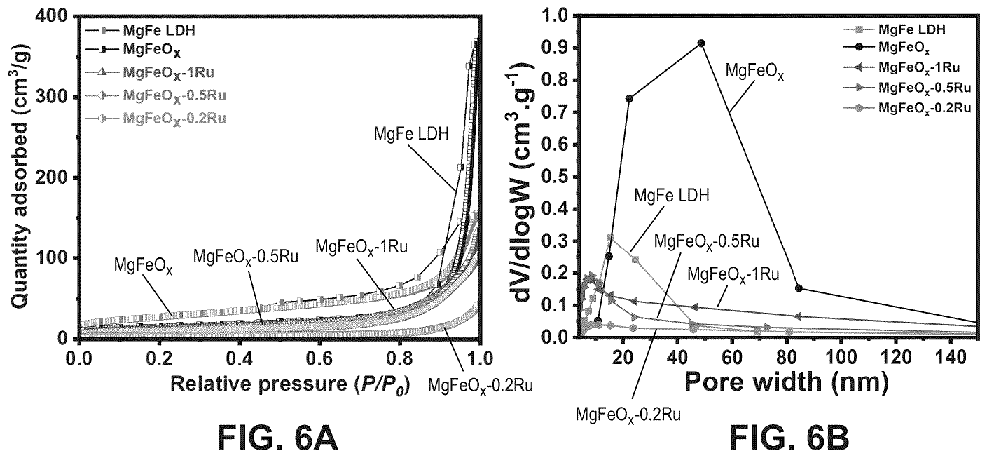

The surface and textural properties of the as-synthesized catalysts were ascertained. FIG. 6(a) shows the N₂ adsorption-desorption hysteresis loops. The MgFeOₓ-nRu catalysts exhibited a Type IV isotherm, indicating the presence of mesoporous characteristics. However, the surface area of the catalysts (Table 1) showed a decreasing trend compared to the support. This decrease in surface area can be attributed to the blockage of pores by the Ru particles. The pore size distribution (FIG. 5(b)) analysis revealed that majority of the pores in the catalysts were in the range of 6-10 nm, as evidenced by the broad peaks observed in contrast to the MgFeOₓ support.

TABLE 1
Surface, texture and chemisorption properties of the
MgFe LDH, MgFeOₓ support, and MgFeOₓ-nRu catalysts.

| | Surface | Pore volume | Pore diameter |
|---|---|---|---|
| Sample | area (m²/g) | (cm³/g) | (nm) |
| MgFe LDH | 88 | 0.2 | 11 |
| MgFeOₓ support | 50 | 0.6 | 45 |
| MgFeOₓ-1Ru | 40 | 0.2 | 21 |
| MgFeOₓ-0.5Ru | 34 | 0.15 | 18 |
| MgFeOₓ-0.2Ru | 13 | 0.06 | 19 |

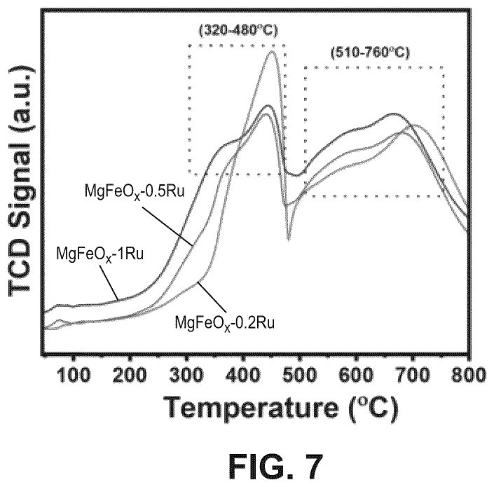

FIG. 7 shows the H₂-TPR profiles of the as-synthesized catalysts in 10% H₂ atmosphere. During the reduction process of the MgFeOₓ-nRu catalysts, two different temperature regimes were observed. Other than that, a small peak is observed in the temperature range of 70-100° C., which belongs to the reduction of RuO₂ leading to the formation of RuO and Ru species. At higher temperatures, specifically in the range of 320-480° C., the reduction of lattice oxygen at the interface of Ru and MgFeOₓ took place. This was followed by the reduction (in the range 510-760° C.) of MgFe₂O₄ to metallic Fe, involving the transformation of Fe³⁺ to Fe²⁺ and Fe²⁺ to Fe⁰. Additionally, during this temperature range, the bonding between Ru and Fe occurred, resulting in the formation of an alloy, which is also evident from TEM analysis (FIG. 5(a)). It was observed that the presence of Ru loading influenced the reduction process. With increasing Ru loading, the reduction peak shifted to higher temperatures, indicating a stronger formation of metal-support interaction (MSI) and alloy formation between Ru and Fe.

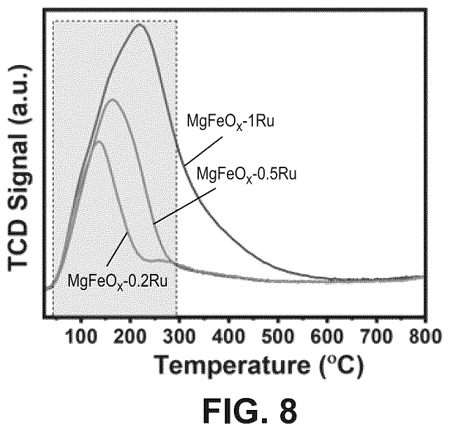

FIG. 8 shows the H₂-TPD profiles of the as synthesized catalysts in 10% H₂ atmosphere. The shape of the peak in the H₂-TPD analysis depends on the loading of Ru on the catalyst. In the case of a low loading of Ru, the Ru sites are more homogeneous, resulting in a bell-shaped peak. This indicates a uniform distribution of Ru species on the catalyst surface. The shift of the peak in the H₂-TPD analysis is influenced by the intensity and quantity of the H₂ molecule. With an increase in the intensity and quantity of H₂, the peak shifts to higher temperatures. This indicates that a higher temperature is required to promote the reduction process and activate the H₂ molecule.

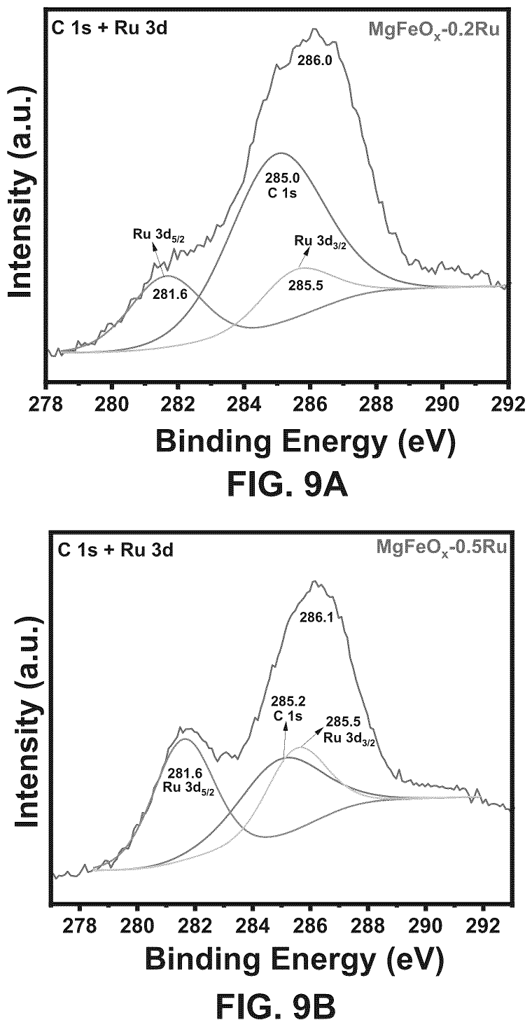

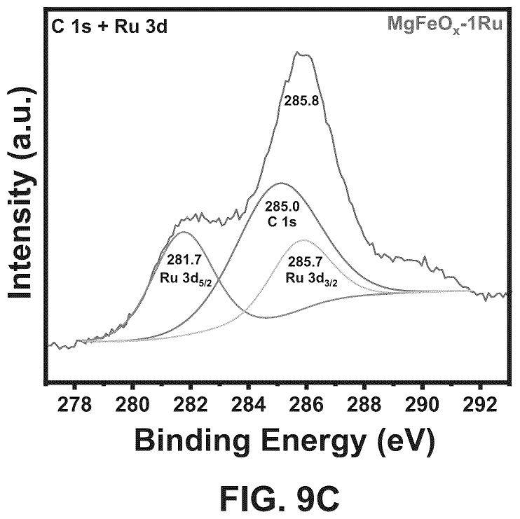

Next, the chemical environment at the surface of the catalysts were studied using XPS (FIG. 9(a)-FIG. 9(c)). The Ru 3d_{5/2} binding energy values observed in the catalyst, namely MgFeOₓ-0.2Ru (281.6 eV), MgFeOₓ-0.5Ru (281.6 eV), and MgFeOₓ-1Ru (281.7 eV), are very close to that of RuO₂ (280.7 eV). These values show a slight increase (ΔBE) of 1.4, 1.4, and 1.5 eV, respectively, compared to bulk metallic Ru (280.2 eV). This phenomenon suggests the presence of oxidized Ru species on the surface layer of the catalyst, as revealed by ex-situ XPS characterization. The oxidation of Ru metal could contribute to the observed binding energy shifts in the Ru 3d_{5/2} peak. Furthermore, the surface atomic percentages of Ru were determined to be 0.1%, 0.3%, and 0.3% for MgFeOₓ-0.2Ru, MgFeOₓ-0.5Ru, and MgFeOₓ-1Ru catalysts, respectively. These results indicate that a significant portion of the Ru species preferentially resides on the catalyst surface. Notably, after reaching a Ru loading of 0.5 wt. %, no further advantage is observed in adding more Ru, as the saturation point has been reached.

### Example 2: Ammonia Synthesis Using Synthesized Ruthenium-Based Catalyst

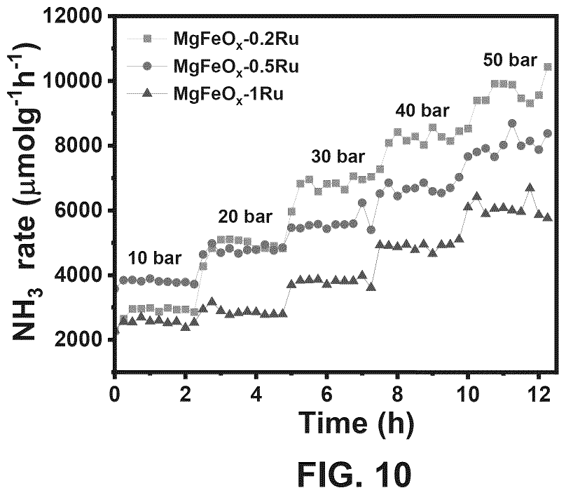

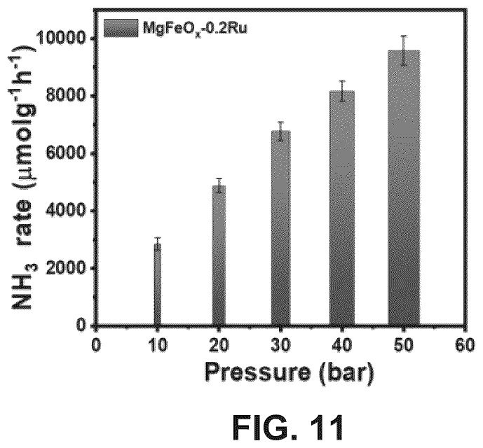

The performance of MgFeOₓ-nRu catalysts in synthesizing NH₃ was evaluated using a feed composition of 25% N₂-75% H₂. The experimental results, shown in FIG. 10, revealed an interesting trend. At a temperature of 400° C. and a pressure of 50 bar, the rate of NH₃ synthesis exhibited a consistent increase as the amount of Ru loading decreased from 1 to 0.2 wt. %. The MgFeOₓ-nRu presents the optimal reaction activity of 10436 μmolg⁻¹ h⁻¹, even with a low Ru loading of 0.2 wt. %, which is higher than that over MgFeOₓ-0.5Ru (8378 μmol g⁻¹ h⁻¹) and MgFeOₓ-1Ru (5763 μmol g⁻¹ h⁻¹) catalysts, respectively. The improved NH₃ formation rate with lower Ru loading is due to the better dispersion of Ru over the support surface, which in turn provides more active sites to involve in catalytic activity. Additionally, the effects of reaction pressure on the catalytic activity of MgFeOₓ-nRu catalysts was investigated. Over MgFeOₓ-0.2Ru, the NH₃ synthesis increases along with the elevation of pressure (FIG. 11). With the increased reaction pressure from 10 to 50 bar, NH₃ synthesis rate increased from 2843 to 9583 μmol g⁻¹ h⁻¹ at 400° C.

### Example 3: Long Term Stability Test of Synthesized Ruthenium-Based Catalyst

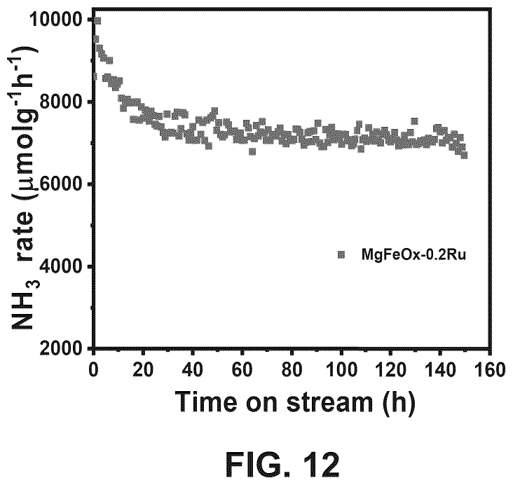

To ensure that the efficiency and reliability of NH₃ production processes using the as-synthesized ruthenium-based catalyst is maintained while reducing costs, a stability test was conducted under specific conditions. The test was performed at a temperature of 400° C., WHSV of 10,000 mLg⁻¹ h⁻¹, and a pressure of 50 bar. The objective of the test was to assess the catalyst's stability and its ability to maintain a consistent NH₃ synthesis rate. The results of the stability test (FIG. 12) were promising, as the catalyst demonstrated high stability over a period of 150 hours. Throughout this duration, the NH₃ synthesis rate remained steady at a value of 7217 μmol g⁻¹ h⁻¹. This indicates that the catalyst exhibited excellent durability and retained its catalytic activity for an extended period. Such stability is crucial for industrial-scale NH₃ production, as it ensures continuous and reliable NH₃ synthesis while minimizing the need for catalyst replacement or regeneration. Moreover, the high NH₃ synthesis rate achieved during the stability test highlights the catalyst's efficiency in converting reactants to the desired product, further contributing to cost reduction in NH₃ production processes.

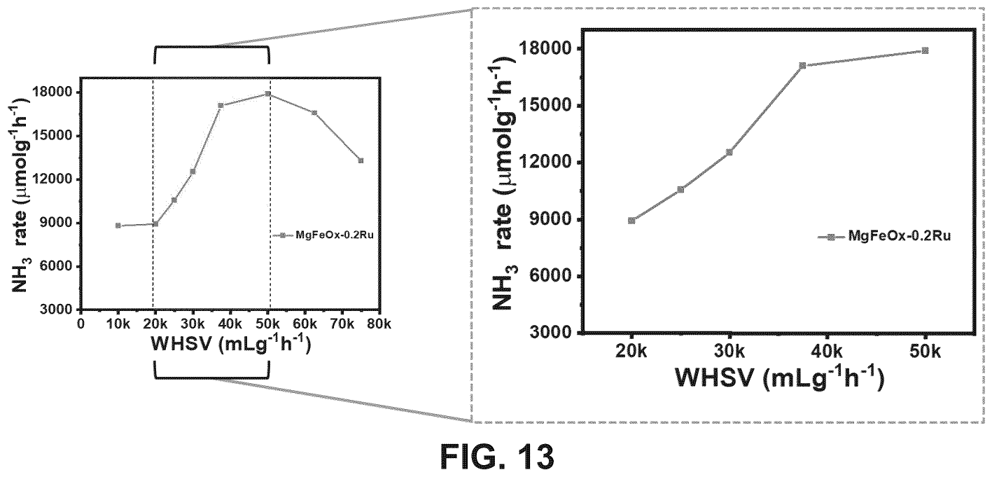

The effect of gas flow rates (WHSV, FIG. 13) was investigated at a temperature of 400° C. and a pressure of 50 bar. WHSV represents the mass of reactants passing through a unit weight of the catalyst per hour, typically measured in units of kg of reactant per kg of catalyst per hour. During the study, different WHSV values were tested to evaluate their impact on the NH₃ synthesis rate. It was found that the catalyst exhibited highest NH₃ synthesis rate at an optimal WHSV of 50000 mLg⁻¹ h⁻¹. At this WHSV, the catalyst demonstrated a remarkable NH₃ synthesis rate of 17897 μmolg⁻¹ h⁻¹. This observation suggests that the catalyst's performance was influenced by the rate at which reactants were flowing through the system. Moreover, the result also shows that the Ru metal was highly active for the catalytic activity even with high flow rate of 50000 mLg⁻¹ h⁻¹. The optimal WHSV value allowed for efficient utilization of the catalyst, resulting in a higher NH₃ synthesis rate. It highlights the importance of carefully optimizing process conditions, such as WHSV, to maximize the productivity and efficiency of NH₃ production.

### Example 4: Comparison of Catalytic Activity to Selected Ru-Based Catalysts for NH₃ Synthesis

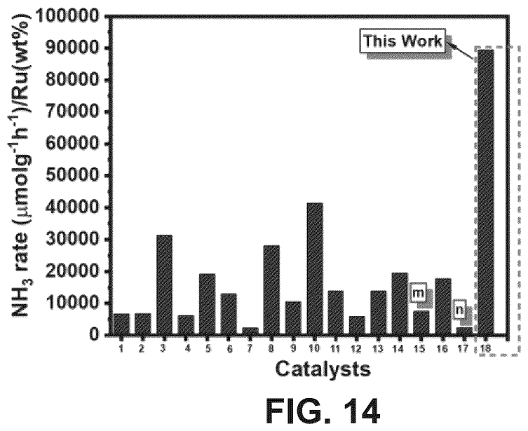

The catalytic activity of the synthesized ruthenium-based catalyst was compared with selected Ru-based catalysts. The findings revealed that the synthesized catalyst described in the present disclosure outperformed the reported literature in terms of NH₃ synthesis efficiency (FIG. 14). In FIG. 14, m has similar compositions as KAAP catalysts; n is commercial Fe catalyst having similar compositions as Mittasch's catalyst.

The normalized NH₃ synthesis rate for the synthesized catalyst was significantly higher compared to the literature values, indicating the superior performance of the synthesized Ru-based catalyst formulation of the present disclosure. Additionally, the synthesized catalyst demonstrated remarkable stability over a 150-hour test, which has significant industrial benefits. The extended stability reduces downtime for catalyst replacement, increases overall productivity, and leads to cost savings in NH₃ production processes. The synthesized catalyst shows great promise for large-scale industrial applications in NH₃ synthesis. Table 2 provides a summary of a comparison of the catalytic performance for NH₃ synthesis between typical Ru- and Fe-based catalysts reported in the literature and the catalyst synthesized in the present disclosure. To make a fair and meaningful comparison, the NH₃ synthesis rates of the catalysts were normalized with respect to the weight percentage of Ru added in each case.

TABLE 2
Comparison of catalytic activity over selected
Ru-based catalysts for NH₃ synthesis.

| | | | | | NH₃ yield | |
|---|---|---|---|---|---|---|
| | | Ru | T | P | (μmol | NH₃ yield/Ru |
| S. No | Catalysts | (wt. %) | (° C.) | (Bar) | g_{cat}⁻¹ h⁻¹) | (wt. %) |
| 1 | Ru/BaCeO₃₋ₓN_{y}H_{z} | 4.5 | 400 | 9 | 30 000 | 6666 |
| 2 | LaN—Ru/ZrH₂ | 2.0 | 350 | 10 | 12800 | 6400 |
| 3 | Ru/BaTiO_{2.5}H_{0.5} | 0.9 | 400 | 50 | 28 200 | 31333 |
| 4 | Ru/La_{0.5}Ce_{0.5}O_{1.75} | 5.0 | 350 | 10 | 31 300 | 6260 |
| 5 | Ru/BaCeO₃ | 1.25 | 400 | 1 | 24 000 | 19200 |
| 6 | Ru/Sm₂O₃ | 5.0 | 400 | 10 | 64 852 | 12970 |
| 7 | Ru/Ba—Ca(NH₂)₂ | 10.0 | 300 | 9 | 23 300 | 2330 |
| 8 | Ba/Ce/Ru ACCs | 2.0 | 400 | 10 | 56 160 | 28080 |
| 9 | Ru/Ba/LaCeOx | 5.0 | 350 | 10 | 52 300 | 10460 |
| 10 | Ba—Ru/BN | 4.5 | 400 | 100 | 186 600 | 41466 |
| 11 | Cs—Ru/G1900/OR | 17.6 | 430 | 100 | ca. 245 535 | 13950 |
| 12 | K—Ru/G1900/OR | 17.6 | 430 | 100 | ca. 103 571 | 5884 |
| 13 | Ba—Ru/G1900/OR | 17.2 | 430 | 100 | ca. 238 314 | 13855 |
| 14 | K—Ba—Cs—Ru/G1900 | 11.8 | 430 | 100 | ca. 230 911 | 19568 |
| 15 | Ba—Cs—Ru/C^{m} | 9.1 | 400 | 90 | 68 500 | 7527 |
| 16 | Ba—Ru—K/AC | 4.0 | 350 | 100 | 70 800 | 17700 |
| 17 | Mittasch's Feⁿ | 40.5 | 460 | 150 | 95 600 | 2360 |
| 18 | MgFeOₓ-0.2Ru | 0.2 | 400 | 50 | 17897 | 89485 |

^{m}similar compositions as KAAP catalysts;
ⁿcommercial Fe catalyst having similar compositions as Mittasch's catalyst.

The catalysts synthesized in the present disclosure exhibited high dispersion of Ru on the LDH-derived support and that the optimal loading of Ru for maximum NH₃ formation rate (17897 μmolg⁻¹ h⁻¹ at 50,000 mLg⁻¹ h⁻¹ weight hourly space velocity (WHSV)) was achieved at 0.2 wt. %. The catalyst also showed a long-term stability of 150 hours with a NH₃ formation rate of 7217 μmolg⁻¹ h⁻¹ at 10,000 mLg⁻¹ h⁻¹ WHSV.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus, the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

### DISCUSSION OF POSSIBLE EMBODIMENTS

The following are non-exclusive descriptions of possible embodiments of the present invention.

According to one aspect, a ruthenium-based catalyst for ammonia synthesis includes a MgFeOₓ support and a ruthenium metal loaded onto the support to form the ruthenium-based catalyst. The ruthenium-based catalyst has the chemical formula of MgFeOₓ—Ru, and x is the number of oxygen atoms present.

The catalyst of the preceding paragraph can optionally include, additionally and/or alternatively any, one or more of the following features, steps, configurations and/or additional components.

In some embodiments, the support is prepared from MgFe layered double hydroxide (LDH).

In some embodiments, an amount of ruthenium present in the ruthenium-based catalyst ranges from about 0.1 to about 1.0 wt %.

In some embodiments, the amount of ruthenium is between about 0.1 and about 0.7 wt %.

In some embodiments, an atomic ratio of Mg to Fe is about 2:1.

In some embodiments, x is equal to four.

In some embodiments, the pore size of the catalyst is in the range of about 4 to about 25 nm.

In some embodiments, the pore size of the catalyst is in the range of about 5 to about 20 nm.

In some embodiments, the pore size of the catalyst is in the range of about 6 to about 10 nm.

In some embodiments, Ru preferentially resides on the surface of the catalyst.

In some embodiments, a rate of ammonia synthesis increases with the increase in pressure when a gas feed composition is exposed to the catalyst.

In some embodiments, the catalyst exhibits stability of about 130-170 hours.

In some embodiments, the stability of the catalyst is about 150 hours.

In some embodiments, the catalyst exhibits stability at temperatures in the range of about 325° C. to about 475° C.

In some embodiments, the catalyst exhibits stability at a temperature of 400° C.

In some embodiments, the catalyst exhibits high catalytic activity at a high flow rate of 50000 mLg⁻¹ h⁻¹.

According to another aspect, a method of making a ruthenium-based catalyst comprises calcining a MgFe LDH powder to form a MgFeOₓ support, loading ruthenium onto the MgFeOₓ support, and reducing the loaded support to form the ruthenium-based catalyst. The ruthenium-based catalyst has a chemical formula of MgFeOₓ—Ru and x is the number of oxygen atoms present.

The method of the preceding paragraph can optionally include, additionally and/or alternatively any, one or more of the following features, steps, configurations and/or additional components.

In some embodiments, an amount of ruthenium present in the ruthenium-based catalyst ranges from about 0.1 to about 1.0% wt.

In some embodiments, the amount of ruthenium is between about 0.1 and about 0.7 wt %.

In some embodiments, the amount of ruthenium is about 0.3 wt %.

In some embodiments, calcining is performed at a temperature ranging between about 550° C. and about 650° C.

In some embodiments, the temperature ranges between about 575° C. and about 625° C.

In some embodiments, the temperature is about 600° C.

In some embodiments, the powder was calcined for a period ranging from about 3 hours to about 7 hours.

In some embodiments, the period is about 5 hours.

In some embodiments, the powder is calcined for a period ranging from about 4 hours to about 9 hours.

In some embodiments, an atomic ratio of Mg to Fe in the catalyst is about 2:1.

In some embodiments, the catalyst has Fe and Ru closely associated with each other in the form of an alloy.

In some embodiments, a pore size of the catalyst is in the range of about 4 to about 25 nm.

In some embodiments, the pore size of the catalyst is in the range of about 5 to about 20 nm.

In some embodiments, the pore size of the catalyst is in the range of about 6 to about 10 nm.

In some embodiments, Ru preferentially resides on the surface of the catalyst.

In some embodiments, the catalyst exhibits stability of about 130-170 hours.

In some embodiments, the stability of the catalyst is about 150 hours.

In some embodiments, the catalyst exhibits stability at temperatures in the range of about 325° C. to about 475° C.

In some embodiments, the catalyst exhibits stability at a temperature of 400° C.

In some embodiments, the catalyst exhibits high catalytic activity at a high flow rate of 50000 mLg⁻¹ h⁻¹.

According to another aspect, a method of synthesizing ammonia from a feed including at least one of nitrogen and hydrogen includes preparing or providing a Ruthenium-based catalyst comprising a MgFeOₓ support and a ruthenium metal loaded onto the support to form the ruthenium-based catalyst, and exposing a gas feed composition comprising N₂ and H₂ to the catalyst at a predetermined flow rate to convert N₂ to NH₃.

The method of the preceding paragraph can optionally include, additionally and/or alternatively any, one or more of the following features, steps, configurations and/or additional components.

In some embodiments, prior to exposing the gas feed composition to the catalyst, the method includes mixing the catalyst with a silicon carbine powder to form a catalyst mixture, and containing the catalyst mixture in a tube reactor.

In some embodiments, the predetermined flow rate is at least 50000 mLg⁻¹ h⁻¹.

In some embodiments, the exposing step is performed at a temperature between about 250 and about 500 degrees Celsius.

In some embodiments, the temperature is about 400 degrees Celsius.

In some embodiments, the exposing step is performed at a pressure between about 10 and about 50 bar.

In some embodiments, the gas feed composition is about 25 percent N₂ and about 75 percent H₂.

Various examples have been described. These and other examples are within the scope of the following claims.

What is claimed is:

1. A ruthenium-based catalyst for ammonia synthesis, comprising:
a MgFeOₓ support; and
a ruthenium metal loaded onto the support to form the ruthenium-based catalyst,
wherein the ruthenium-based catalyst has the chemical formula of MgFeOₓ—Ru, and x is the number of oxygen atoms present.

2. The catalyst of claim 1, wherein the support is prepared from MgFe layered double hydroxide (LDH).

3. The catalyst of claim 1, wherein an amount of ruthenium present in the ruthenium-based catalyst ranges from about 0.1 to about 1.0 wt %.

4. The catalyst of claim 1, wherein an atomic ratio of Mg to Fe is about 2:1.

5. The catalyst of claim 1, wherein x is equal to four.

6. The catalyst of claim 1, wherein the pore size of the catalyst is in the range of about 4 to about 25 nm.

7. The catalyst of claim 1, wherein the catalyst exhibits stability of about 130-170 hours.

8. The catalyst of claim 1, wherein the catalyst exhibits stability at temperatures in the range of about 325° C. to about 475° C.

9. The catalyst of claim 1, wherein the catalyst exhibits high catalytic activity at a high flow rate of 50000 mLg⁻¹ h⁻¹.

10. A method of making of a ruthenium-based catalyst, the method comprising:
calcining a MgFe LDH powder to form a MgFeOₓ support;
loading ruthenium onto the MgFeOₓ support; and
reducing the loaded support to form the ruthenium-based catalyst,
wherein the ruthenium-based catalyst has a chemical formula of MgFeOₓ—Ru and x is the number of oxygen atoms present.

11. The method of claim 10, wherein an amount of ruthenium present in the ruthenium-based catalyst ranges from about 0.1 to about 1.0% wt.

12. The method of claim 10, wherein calcining is performed at a temperature ranging between about 550° C. and about 650° C.

13. The method of claim 10, wherein the powder was calcined for a period ranging from about 3 hours to about 7 hours.

14. The method of claim 10, wherein an atomic ratio of Mg to Fe in the catalyst is about 2:1.

15. The method of claim 10, wherein the catalyst exhibits stability of about 130-170 hours.

16. A method of synthesizing ammonia from a feed including at least one of nitrogen and hydrogen, the method comprising:
preparing or providing a Ruthenium-based catalyst comprising a MgFeOₓ support and a ruthenium metal loaded onto the support to form the ruthenium-based catalyst; and
exposing a gas feed composition comprising N₂ and H₂ to the catalyst at a predetermined flow rate to convert N₂ to NH₃.

17. The method of claim 16 further comprising, prior to exposing the gas feed composition to the catalyst:
mixing the catalyst with a silicon carbine powder to form a catalyst mixture; and
containing the catalyst mixture in a tube reactor.

18. The method of claim 16, wherein the predetermined flow rate is at least 50000 mLg⁻¹ h⁻¹.

19. The method of claim 16 wherein the exposing step is performed at a temperature between about 250 and about 500 degrees Celsius.

20. The method of claim 16, wherein the exposing step is performed at a pressure between about 10 and about 50 bar.
